(19) United States
(12) Patent Application Publication
(10) Pub. No.: US 2021/0197863 A1
(43) Pub. Date: Jul. 1, 2021

(54) VEHICLE CONTROL DEVICE, METHOD, AND PROGRAM

(71) Applicant: HONDA MOTOR CO., LTD., Tokyo (JP)

(72) Inventors: Hiroto HOTTA, Wako-shi (JP); Naokatsu SATO, Wako-shi (JP); Yoshitaka MIMURA, Wako-shi (JP)

(21) Appl. No.: 17/132,022

(22) Filed: Dec. 23, 2020

(30) Foreign Application Priority Data
Dec. 27, 2019 (JP) 2019-238613

(51) Int. Cl. B60W 60/00; B60W 50/14; B60Q 1/50; G06K 9/00

(52) U.S. Cl. CPC B60W 60/0017; B60W 50/14; B60W 2050/146; G06K 9/00791; B60W 2554/4046; B60Q 1/503

(57) ABSTRACT

A vehicle control device facilitates giving a feeling of security to a driver and passengers of an autonomous driving host vehicle M. The vehicle control device includes a recognition unit recognizing circumstances surrounding the vehicle, a travel control unit controlling at least one of steering and acceleration of the vehicle based on the circumstances surrounding the vehicle, an external notification unit notifying the traffic participants recognized by the recognition unit of a behavior of the host vehicle based on a control by the travel control unit, an internal notification unit notifying the driver of the information notified to the traffic participant through the external notification unit when the host vehicle M is within a predetermined area of the intersection, and a notification control unit stopping the notifications when the vehicle is not in the area.

### CROSS REFERENCE TO RELATED APPLICATIONS

This application claims benefit of foreign priority to Japanese Patent Application No. 2019-238613, filed on Dec. 27, 2019, which is incorporated by reference in its entirety.

### TECHNICAL FIELD

The present invention relates to a vehicle control device, vehicle control method, and vehicle control program.

### BACKGROUND ART

An autonomous vehicle, which has been developed in recent year, allows a driver not to operate the autonomous vehicle while it is travelling, which often makes the driver inside the vehicle seen as paying no attention to the external situation. This may make traffic participants such as pedestrians around this autonomous vehicle feel unsafe due to no assurance about whether or not this vehicle is aware and driving with care of them.

Accordingly, PTL 1 discloses an art of a movable device provided in an autonomous vehicle and directed toward a pedestrian when the vehicle detects the pedestrian to inform the pedestrian that the vehicle is driving while taking care of the pedestrian.

Alternatively, PTL 2 discloses a technique of an autonomous vehicle recognizing persons in the vicinity of the vehicle and outputting information directing toward the person.

### CITATION LIST

### Patent Literature

PTL 1: Japanese Patent Application Publication No. 2015-174541

PTL 2: Japanese Patent Application Publication No. 2017-199317

### SUMMARY OF THE INVENTION

### Technical Problem

Techniques of PTLs 1 and 2 give pedestrians or the like around the autonomous vehicle feeling of safety by informing them that the vehicle is driving while paying attention to them.

However, the techniques of PTLs 1 and 2 do not secure to the driver of the autonomous vehicle whether or not the autonomous vehicle is informing traffic participants such as pedestrians around the vehicle that the autonomous vehicle is driving while paying attention to the participants, and what kind of notification is being informed. Therefore, there is a problem that the driver of the autonomous vehicle may feel uneasy.

Accordingly, if the autonomous vehicle notifies its driver that the vehicle is informing the traffic participants nearby the vehicle that the autonomous vehicle is driving while paying attention to the participants, the driver's anxiety can be reduced.

However, it is usually restricted only to a case when the vehicle is in a specific situation, such as when the vehicle is located in an intersection that the autonomous vehicle needs to notify the traffic participants. Continuing to give the above notification to other traffic participants even when they are not located in such a specific scene may cause confusion for the other traffic participants. For this reason, notifying a driver of the autonomous vehicle that it is always continuing such a notification to traffic participants may induct to the driver anxiety that the vehicle might cause confusion for the traffic participants.

Further, it may give the driver troublesome feeling to continually notify to the driver of the autonomous vehicle of even the case when they are not located in such a specific scene. Further, when the notification to the driver is performed all the time through a display in the vehicle, notification of other information through the display is hindered in the vehicle.

Accordingly, it is an object of the present invention to provide a vehicle control device, a method and a program for vehicle control that can facilitate giving a sense of security to the driver or passengers when notifying them that the vehicle is notifying traffic participants surrounding it that it is driving while paying attention to the traffic participants.

### Solution to Problem

The present invention provides a vehicle control device including a recognition unit recognizing surrounding circumstances of a host vehicle, a travel control unit controlling at least one of steering and acceleration of the host vehicle on a basis of the surrounding circumstances recognized by the recognition unit, an external notification unit notifying a traffic participant recognized by the recognition unit about a behavior of the host vehicle based on a control by the travel control unit, and an internal notification unit notifying a driver of the host vehicle about notified information given to the traffic participant through the external notification unit, and a notification control unit that makes the internal notification unit notify the driver of the host vehicle about the notified information when the host vehicle is located in the specific scene; and stops the internal notification unit to notify the driver of the host vehicle about the notified information when the host vehicle is not located in the specific scene.

### Advantageous Effects of Invention

The present invention provides a vehicle control device, a method and a program for vehicle control that can facilitate giving a sense of security to the driver or passengers when notifying them that the vehicle is notifying surrounding traffic participants that the vehicle is driving while paying attention to them.

### BRIEF DESCRIPTION OF THE DRAWINGS

FIG. 1 is an entire configuration diagram of a vehicle including a vehicle control device according to an embodiment of the present invention.

FIG. 2 is a functional block configuration diagram illustrating a vehicle control device and its peripheral components according to an embodiment of the present invention.

FIG. 3 is a schematic configuration diagram of a human machine interface (HMI) connected to the vehicle control device according to an embodiment of the present invention.

FIG. 4 is a diagram illustrating a front structure of a cabin of the vehicle including the vehicle control device according to an embodiment of the present invention.

FIG. 5A is an exterior diagram illustrating a front structure of the vehicle including the vehicle control device according to an embodiment of the present invention.

FIG. 5B is an exterior diagram illustrating a rear structure of the vehicle including the vehicle control device according to an embodiment of the present invention.

FIG. 5C is a front view illustrating a schematic configuration of a right front light unit included in the vehicle.

FIG. 6 is a functional block diagram illustrating details of a display control unit of the vehicle control device according to the embodiment of the present invention.

FIG. 7A is a front view illustrating a pattern of a notification with the right front lighting unit and a left front lighting unit performed by the vehicle control device according to the embodiment of the present invention.

FIG. 7B is a front view illustrating the pattern of the notification with the right front lighting unit and the left front lighting unit performed by the vehicle control device according to the embodiment of the present invention.

FIG. 7C is a front view illustrating the pattern of the notification with the right front lighting unit and the left front lighting unit performed by the vehicle control device according to the embodiment of the present invention.

FIG. 7D is a front view illustrating the pattern of the notification with the right front lighting unit and the left front lighting unit performed by the vehicle control device according to the embodiment of the present invention.

FIG. 8 is a front view showing an image display example of a multi-information panel from the vehicle control device according to the embodiment of the present invention.

FIG. 9 is a front view of the multi-information panel when displaying notification information relating to a guidance from the vehicle control device according to the embodiment of the present invention.

FIG. 10A is a front view of an image display example of a notification display displayed in an external notification display area from the vehicle control device according to the embodiment of the present invention.

FIG. 10B is a front view of an image display example of a non-notification display displayed in the external notification display area from the vehicle control device according to the embodiment of the present invention.

FIG. 11 is a flowchart illustrating a process executed by a notification control unit or the like of the vehicle control device according to the embodiment of the present invention.

FIG. 12 is a plan view schematically showing the host vehicle entering an intersection for explaining control by the vehicle control device according to the embodiment of the present invention.

### DESCRIPTION OF EMBODIMENTS

Hereinbelow, a description is given of a vehicle control device according to an embodiment of the present invention in detail with reference to the drawings.

Note that, the drawings presented below denotes members having the same function with the same reference sign. Moreover, the sizes and shapes of members may be changed or exaggerated and schematically illustrated for convenience of explanation.

When the terms “ right” and “ left” are used in relation to a host vehicle M in the description of the vehicle control device according to the embodiments of the present invention, the front side of the host vehicle M in the advancing direction is the reference direction. Specifically, in a case where the host vehicle M is, for example, right-hand drive, the driver's seat side will be referred to as the right, and the passenger's seat side will be referred to as the left.

### Configuration of Host Vehicle M

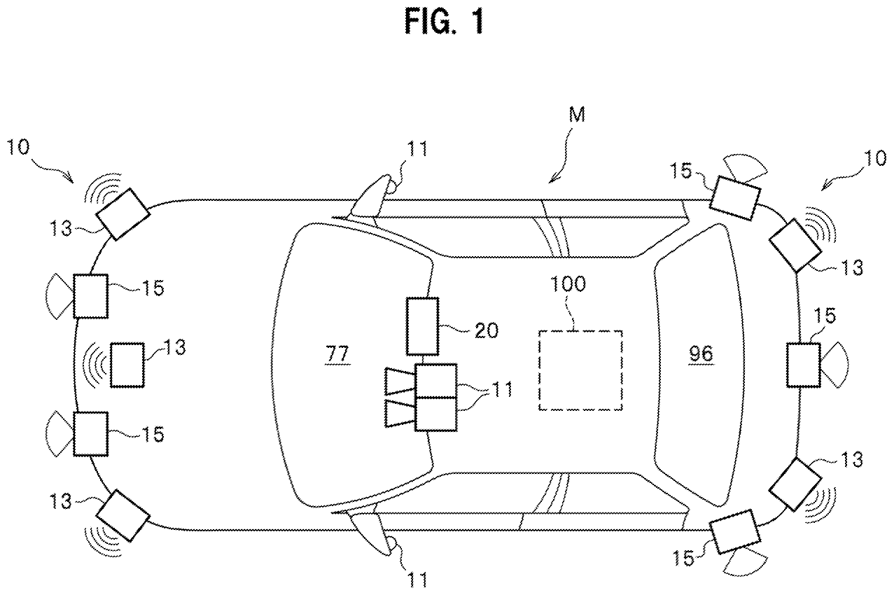

First of all, description is given of a configuration of a vehicle including a vehicle control device 100 according to an embodiment of present invention (hereinafter referred to as “host vehicle M”) with reference to FIG. 1.

FIG. 1 is an entire configuration diagram of the vehicle including the vehicle control device 100 according to the embodiment of the present invention.

As illustrated in FIG. 1, the host vehicle M equipped with the vehicle control device 100 according to the embodiment of the present invention is an automobile such as a two-wheeled, three-wheeled, or four-wheeled automobile.

The host vehicle M is, for example, an automobile with an internal combustion engine such as a diesel engine or a gasoline engine as a power source, an electric automobile with an electric motor as a power source, a hybrid automobile with both the internal combustion engine and the electric motor, and the like. Among these vehicles, the electric automobile is driven by, for example, electric power discharged from a cell such as a secondary cell, a hydrogen fuel cell, a metal fuel cell, or an alcohol fuel cell.

As illustrated in FIG. 1, the host vehicle M is equipped with: an external sensor 10 having a function of detecting outside information on targets including objects and signs present around the host vehicle M; a navigation device 20 having a function of mapping the current position of the host vehicle M onto a map, guiding the host vehicle M to a destination through a route, and so on; and the vehicle control device 100 having a function of controlling autonomous driving (self-driving) of the host vehicle M including the steering and the acceleration and deceleration of the host vehicle M and the like.

These devices and instruments are configured such that they are connected so as to be capable of communicating data to each other through a communication medium such as a controller area network (CAN).

Note that the “vehicle control device” according to the present invention may include other components such as the external sensor 10 and an HMI 35 in addition to the components of the “vehicle control device 100” according to this embodiment.

### External Sensor 10

The external sensor 10 includes cameras 11, radars 13, and LiDARs (Light Detection and Ranging) 15.

The cameras 11 have an optical axis orientated toward the front side of the host vehicle and tilted obliquely downward, and has a function of capturing image in the direction of advance of the host vehicle M. The cameras 11 can be, for example, a complementary metal oxide semiconductor (CMOS) camera, a charge coupled device (CCD) camera, or the like. The cameras 11 are provided near a rearview mirror (not illustrated) inside the cabin of the host vehicle M and on a front portion of a right door and a front portion of a left door outside the cabin of the host vehicle M, or the like.

The cameras 11 repetitively capture images of, for example, a front in the direction of advance, a right rear side, and a left rear side relative to the host vehicle M on a periodic basis. In this embodiment, the camera 11 provided near the rearview mirror is a pair of monocular cameras arranged side by side. The camera 11 may be a stereo camera.

The pieces of image information on the front in the direction of advance, the right rear side, and the left rear side relative to the host vehicle M captured by the cameras 11 are transmitted to the vehicle control device 100 through the communication medium.

The radars 13 have a function of obtaining distribution information on targets including a leading vehicle being a following target traveling ahead of the host vehicle M by emitting radar waves to the targets and receiving the radar waves reflected by the targets, the distribution information including the distances to the targets and the directions of the targets. Laser beams, microwaves, millimeter waves, ultrasonic waves, or the like can be used as the radar waves as appropriate.

In this embodiment, five radars 13 are provided, three on the front portions and two on the rear portions, as illustrated in FIG. 1. The target distribution information obtained by the radars 13 is transmitted to the vehicle control device 100 through the communication medium.

The LiDARs 15 have a function of detecting a presence of a target and a distance to a target, for example, by measuring a time taken to detect scattered light corresponding to emitted light. In this embodiment, five LiDARs 15 are provided, two on the front portion and three on the rear portion, as illustrated in FIG. 1. The target distribution information obtained by the LiDARs 15 is transmitted to the vehicle control device 100 through the communication medium.

### Navigation Device 20

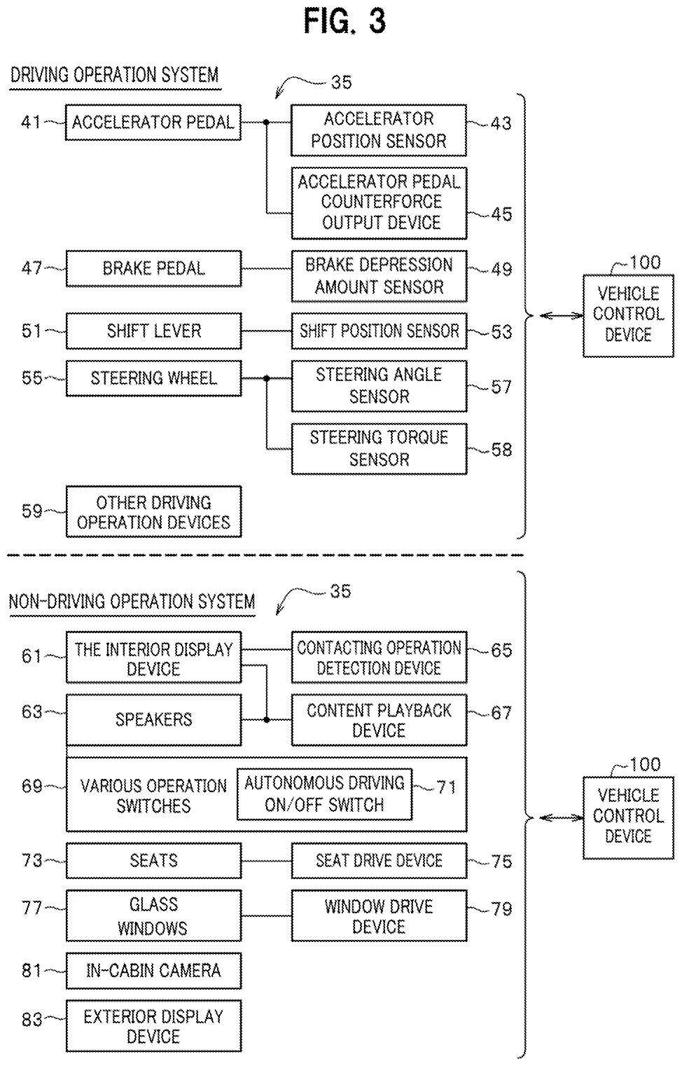

The navigation device 20 includes a global navigation satellite system (GNSS) receiver, map information (navigation map), a touchscreen-type interior display device 61, speakers 63 (see FIG. 3 for these two), a microphone, and the like, functioning as a human machine interface. The navigation device 20 serves to locate the current position of the host vehicle M with the GNSS receiver and also to derive a route from the current position to a destination designated by the user.

The route derived by the navigation device 20 is provided to a target lane determination unit 110 (described below) of the vehicle control device 100. The current position of the host vehicle M may be identified or complemented by an inertial navigation system (INS) utilizing an output of a vehicle sensor 30. Also, the navigation device 20 navigates a route to a destination by using sound and voice or by displaying a map.

Note that the function of locating the current position of the host vehicle M may be provided independently of the navigation device 20. Also, the navigation device 20 may be implemented by a function of a terminal device such as a smartphone or tablet carried by the user. In this case, information is transmitted and received between the terminal device and the vehicle control device 100 via wireless or wired communication.

### Vehicle Control Device 100 and Its Peripheral Components

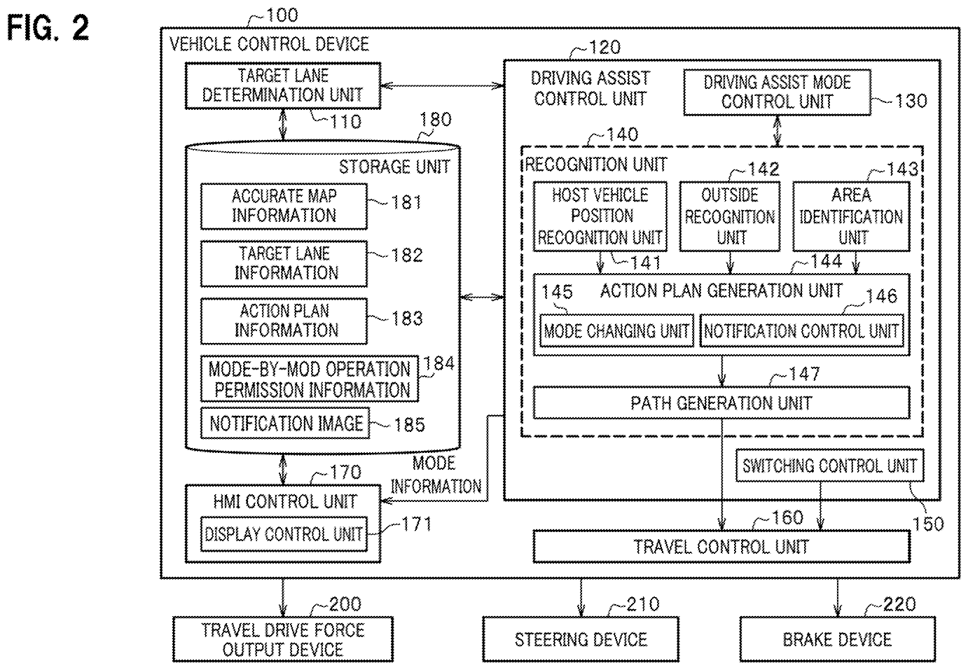

Next, the vehicle control device 100 and its peripheral components mounted on the host vehicle M according to an embodiment of the present invention is described with reference to FIG. 2.

FIG. 2 is a functional block configuration diagram illustrating the vehicle control device 100 and its peripheral components according to the embodiment of the present invention.

As illustrated in FIG. 2, the host vehicle M is equipped with a communication device 25, the vehicle sensor 30, the HMI 35, a travel drive force output device 200, a steering device 210, and a brake device 220, as well as the above-described external sensor 10, the navigation device 20, and the vehicle control device 100.

The communication device 25, the vehicle sensor 30, the HMI 35, the travel drive force output device 200, the steering device 210, and the brake device 220 are configured such that they are connected to the vehicle control device 100 so as to be capable of communicating data to and from the vehicle control device 100 through the communication medium.

### Communication Device 25

The communication device 25 has a function of performing communication through a wireless communication medium such as a cellular network, a Wi-Fi network, Bluetooth (registered trademark), or a dedicated short-range communication (DSRC), for example.

The communication device 25 wirelessly communicates with, for example, an information providing server of a system that monitors the traffic situations of roads, such as the Vehicle Information and Communication System (VICS: registered trademark) to obtain traffic information indicating the traffic situation of the road on which the host vehicle M is currently traveling or a road on which the host vehicle M will be traveling. The traffic information contains pieces of information such as information on congestion ahead, information on times required to pass through congested areas, information on accidents, disabled vehicles, and construction, information on speed restrictions and lane restrictions, information on locations of parking lots, and information on availability of parking lots and rest areas.

The communication device 25 may obtain the traffic information by, for example, communicating with a radio beacon provided on a side margin of the road or the like or performing vehicle-to-vehicle communication with another vehicle traveling around the host vehicle M.

The communication device 25 also wirelessly communicates with, for example, an information providing server of the Traffic Signal Prediction Systems (TSPS) and obtains traffic signal information on traffic lights provided on the road which the host vehicle M is currently traveling or a road which the host vehicle M will be traveling. The TSPS serves to assist driving to smoothly cross intersections with traffic lights by using the traffic signal information on the traffic lights.

The communication device 25 is able to obtain the traffic signal information by, for example, communicating with an optical beacon provided on a side margin of the road or the like or performing vehicle-to-vehicle communication with another vehicle traveling nearby the host vehicle M.

### Vehicle Sensor 30

The vehicle sensor 30 has a function of detecting various pieces of information on the host vehicle M. The vehicle sensor 30 includes: a vehicle speed sensor that detects the vehicle speed of the host vehicle M; an acceleration sensor that detects an acceleration of the host vehicle M; a yaw rate sensor that detects an angular speed of the host vehicle M about a vertical axis; an direction sensor that detects the direction of the host vehicle M; a tilt angle sensor that detects the tilt angle of the host vehicle M; an illuminance sensor that detects illuminance of the area where the host vehicle M is present; a raindrop sensor that detects an amount of raindrop at the area where the host vehicle M is present; and so on.

### Configuration of HMI 35

Next, the HMI 35 is described with reference to FIGS. 3, 4, 5A, and 5B.

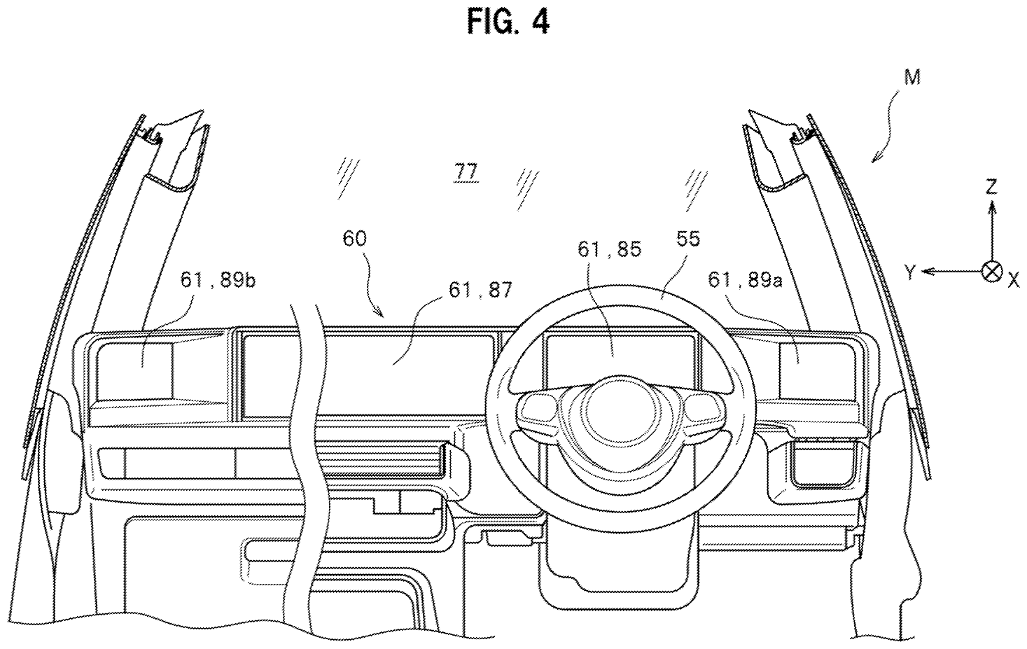

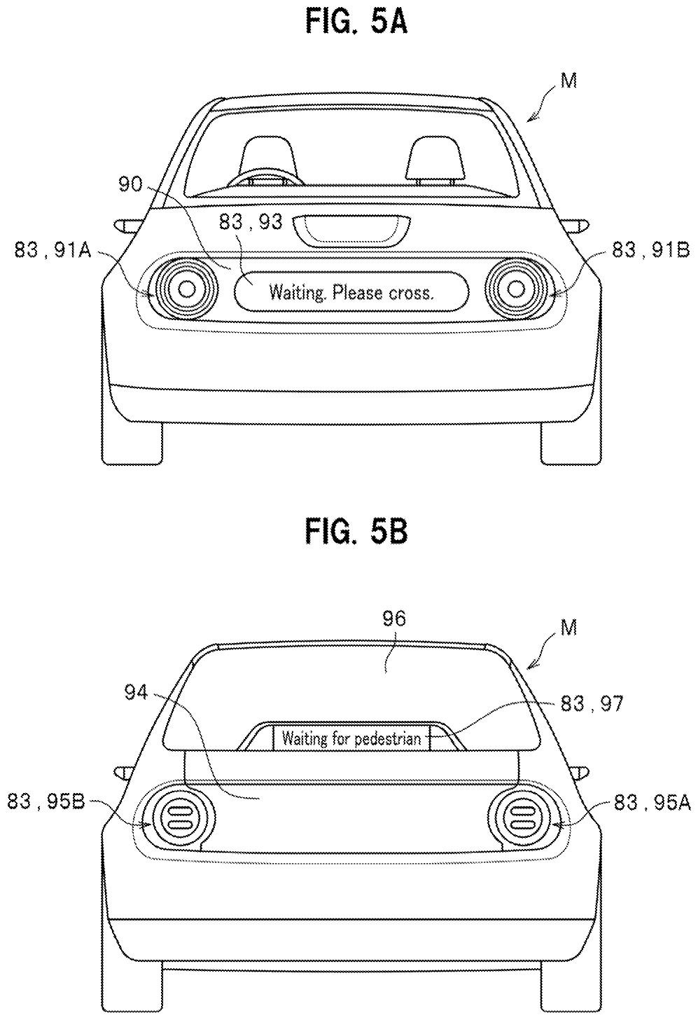

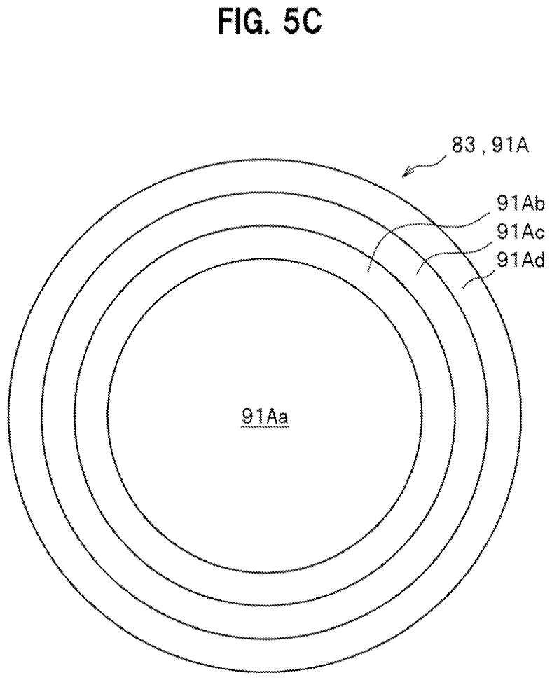

FIG. 3 is a schematic configuration diagram of the HMI 35 connected to the vehicle control device 100 according to the embodiment of the present invention. FIG. 4 is a diagram illustrating a front structure of the cabin of the host vehicle M including the vehicle control device 100. FIGS. 5A and 5B are exterior diagrams illustrating a front structure and a rear structure of the host vehicle M including the vehicle control device 100, respectively.

As illustrated in FIG. 3, the HMI 35 includes configuration members of a driving operation system and configuration members of a non-driving operation system. There is no clear boundary between them, and a configuration in which configuration members of the driving operation system includes functions of the non-driving operation system (or vice versa) may be employed.

As illustrated in FIG. 3, the HMI 35 includes, as the configuration members of the driving operation system: an accelerator pedal 41, an accelerator position sensor 43, and an accelerator pedal counterforce output device 45; a brake pedal 47 and a brake depression amount sensor 49; a shift lever 51 and a shift position sensor 53; a steering wheel 55, a steering angle sensor 57 and a steering torque sensor 58; and other driving operation devices 59.

The accelerator pedal 41 is an acceleration operator that receives an acceleration instruction (or a deceleration instruction by a returning operation) by the driver. The accelerator position sensor 43 detects the amount of depression of the accelerator pedal 41 and outputs an accelerator position signal indicating the amount of the depression to the vehicle control device 100.

Note that a configuration may be employed which outputs the accelerator position signal directly to the travel drive force output device 200, the steering device 210, or the brake device 220, instead of outputting the accelerator position signal to the vehicle control device 100. This applies also to the other components of the driving operation system to be described below. The accelerator pedal counterforce output device 45 outputs a force (operation counterforce) to the accelerator pedal 41 in the opposite direction to the direction in which the accelerator pedal 41 is operated, for example, in accordance with an instruction from the vehicle control device 100.

The brake pedal 47 is a deceleration operator that receives a deceleration instruction from the driver. The brake depression amount sensor 49 detects the amount of depression of (or the force of depression on) the brake pedal 47, and outputs a brake signal indicating a result of the detection to the vehicle control device 100.

The shift lever 51 is a gearshift operator that receives a shift stage change instruction by the driver. The shift position sensor 53 detects a shift stage designated by the driver and outputs a shift position signal indicating a result of the detection to the vehicle control device 100.

The steering wheel 55 is a steering operator that receives a turn instruction from the driver. The steering angle sensor 57 detects the operation angle of the steering wheel 55, and outputs a steering angle signal indicating a result of the detection to the vehicle control device 100. The steering torque sensor 58 detects a torque applied to the steering wheel 55, and outputs a steering torque signal indicating a result of the detection to the vehicle control device 100.

The other driving operation devices 59 are, for example, a joystick, a button, a rotary switch, a graphical user interface (GUI) switch, and so on. The other driving operation devices 59 receive an acceleration instruction, a deceleration instruction, a turn instruction, and so on and output them to the vehicle control device 100.

As illustrated in FIG. 3, the HMI 35 includes, as the configuration members of the non-driving operation system: for example, the interior display device 61; the speakers 63; a contacting operation detection device 65 and a content playback device 67; various operation switches 69; seats 73 and a seat drive device 75; glass windows 77 and a window drive device 79; an in-cabin camera 81; and an exterior display device 83.

The interior display device 61 is a display device preferably of a touchscreen type having a function of displaying various pieces of information to the occupants in the cabin. As illustrated in FIG. 4, the interior display device 61 includes, in an instrument panel 60: a meter panel 85 provided at a position directly opposite the driver's seat; a multi-information panel 87 horizontally elongated in the vehicle width direction and provided so as to face from the drivers seat to the passenger's seat; a right panel 89a provided on an end near the driver's seat in the vehicle width direction; and a left panel 89b provided on an end near the passenger's seat in the vehicle width direction. Note that the interior display device 61 may be provided additionally at such a position as to face the rear seats (the back side of all seats).

The meter panel 85 displays, for example, a speedometer, a tachometer, an odometer, shift position information, on/off information on lights, and so on.

The multi-information panel 87 displays, for example: map information on the area around the host vehicle M; information on the current position of the host vehicle M on the map; traffic information (including traffic signal information) on the road which the host vehicle M is currently traveling or a route which the host vehicle M will be traveling; traffic participant information on traffic participants (including pedestrians, bicycles, motorcycles, other vehicles, and so on) present around/nearby the host vehicle M; various pieces of information such as messages to be presented to the traffic participants; and so on.

The right panel 89a displays image information on a right rear location and a right lower location relative to the host vehicle M captured by the camera 11 provided on the right side of the host vehicle M.

The left panel 89b displays image information on a left rear location and a left lower location relative to the host vehicle M captured by the camera 11 provided on the left side of the host vehicle M.

The interior display device 61 is formed of, for example, liquid crystal displays (LCDs), organic electroluminescence (EL) displays, or the like, but not limited thereto. The interior display device 61 may be formed of head-up displays (HUDs) that project necessary images on the glass windows 77.

The speakers 63 have a function of outputting voice and sound. An appropriate number of speakers 63 are provided at appropriate positions inside the cabin such as at the instrument panel 60, the door panels, and the rear parcel shelf (none of which is illustrated).

When the interior display device 61 is of a touchscreen type, the contacting operation detection device 65 has a function of detecting a touched position on any of the display screens of the interior display device 61 and outputting information on the detected touched position to the vehicle control device 100. The contacting operation detection device 65 can omit this function when the interior display device 61 is not of a touchscreen type.

The content playback device 67 includes, for example, a digital versatile disc (DVD) playback device, a compact disc (CD) playback device, a television receiver, a playback device for various guide images, and so on. Some or all of the interior display device 61, the speakers 63, the contacting operation detection device 65, and the content playback device 67 may be components also used by the navigation device 20.

The various operation switches 69 are arranged at appropriate positions inside the cabin. The various operation switches 69 include an autonomous driving ON/OFF switch 71 that issues an instruction to immediately start autonomous driving (or to start autonomous driving in the future) or to stop autonomous driving. The autonomous driving ON/OFF switch 71 may be a GUI switch or a mechanical switch. The various operation switches 69 may also include switches for driving the seat drive device 75 and the window drive device 79.

The seats 73 are seats for the occupants in the host vehicle M to sit on. The seat drive device 75 drives the seats 73 freely at any reclining angles, front-rear positions, yaw angles, and the like. The glass windows 77 are provided to, for example, all doors. The window drive device 79 drive some of the glass windows so as to open or close them.

The in-cabin camera 81 is a digital camera utilizing a solid-state imaging element, such as a CCD or a CMOS. The in-cabin camera 81 is provided at such a position as to be capable of capturing an image of at least a head of the driver sitting on the driver's seat, such as in the rearview mirror, the steering boss (neither of which is illustrated), or the instrument panel 60. In an example, the in-cabin camera 81 repetitively captures image of, for example, the inside of the cabin including the driver on a periodic basis.

The exterior display device 83 has a function of displaying various pieces of information to traffic participants present around the host vehicle M (including pedestrians, bicycles, motorcycles, other vehicles, and so on). As illustrated in FIG. 5A, the exterior display device 83 includes, in a front grill 90 of the host vehicle M, a right front light unit 91A and a left front light unit 91B provided separated from each other in the vehicle width direction, and a front display unit 93 provided between the right and left front light units 91A and 91B.

As illustrated in FIG. 5B, the exterior display device 83 also includes, in a rear grill 94 of the host vehicle M, a right rear light unit 95A and a left rear light unit 95B provided separated from each other in the vehicle width direction, and a rear display unit 97 provided at a position inside the cabin of the host vehicle M at which the rear display unit 97 is visible from outside through a center lower portion of a rear window 96. The rear display unit 97 is provided, for example, at the lower end of an opening for the rear window 96 (not illustrated) or the like.

Here, the configurations of the right and left front light units 91A and 91B of the exterior display device 83 will now be described with reference to FIG. 5C. FIG. 5C is a front view illustrating a schematic configuration of the right front light unit 91A included in the host vehicle M. Note that the right and left front light units 91A and 91B have the same configuration, and thus, the schematic configuration of the right front light unit 91A is described as a description of the configurations of the right and left front light units 91A and 91B.

The right front light unit 91A is formed in a circular shape in a front view. The right front light unit 91A is configured such that a turn signal 91Ab, a light display part 91Ac, and a position lamp 91Ad each formed in an annular shape are arranged concentrically in this order toward the radially outer side and centered around a headlamp 91Aa formed in a circular shape in a front view having a smaller diameter than the outer diameter of the right front light unit 91A.

The headlamp 91Aa serves to assist the occupant to view ahead while the host vehicle M is traveling through a dark area by illuminating the front direction in the advance direction with light. The turn signal 91Ab serves to notify traffic participants present around the host vehicle M of an intention to turn right or left when the host vehicle M does so. The light display part 91Ac serves to notify traffic participants present around the host vehicle M of traveling intention of the host vehicle M including stopping (this is described below in detail) along with a content displayed on the front display unit 93. The position lamp 91Ad serves to notify traffic participants present around the host vehicle M of its vehicle width while the host vehicle M is traveling through a dark area.

### Configuration of Vehicle control Device 100

Next, referring back to FIG. 2, description is given of a configuration of the vehicle control device 100.

The vehicle control device 100 is implemented by, for example, at least one processor or hardware having the equivalent function. The vehicle control device 100 may be includes a combination of electronic control units (ECUs), micro-processing units (MPUs), or the like in each of which a processor such as a central processing unit (CPU), a storage device, and a communication interface are connected by an internal bus.

The vehicle control device 100 includes the target lane determination unit 110, a driving assist control unit 120, a travel control unit 160, an HMI control unit 170, and a storage unit 180.

The functions of the target lane determination unit 110 and the driving assist control unit 120 and part or entirety of the function of the travel control unit 160 are implemented by the processor executing programs (software). Also, some or all of these functions may be implemented by hardware such as a large-scale integration (LSI) circuit or an application specific integrated circuit (ASIC) or by a combination of software and hardware.

In the following description, when a subject is mentioned like “˜ unit does . . . ”, the driving assist control unit 120 reads out the corresponding program from a read only memory (ROM) or an electrically erasable programmable read-only memory (EEPROM) as necessary, loads it into a random-access memory (RAM), and executes the corresponding function (described below).

The program may be prestored in the storage unit 180 or taken into the vehicle control device 100 from another storage medium or through a communication medium as necessary.

### Target Lane Determination Unit 110

The target lane determination unit 110 is implemented by a micro processing unit (MPU), for example. The target lane determination unit 110 divides a route provided from the navigation device 20 into a plurality of blocks (for example, divides the route at 100 [m]-intervals in the direction of advance of the vehicle), and determines a target lane in each block by referring to accurate map information 181. For example, the target lane determination unit 110 determines which lane from the left to travel. When, for example, a branching point, a merging point, or the like is present on the route, the target lane determination unit 110 determines the target lane such that the host vehicle M will be able to travel a rational traveling route for advancing to the target branched path. The target lane determined by the target lane determination unit 110 is stored in the storage unit 180 as target lane information 182.

### Driving Assist Control Unit 120

The driving assist control unit 120 includes a driving assist mode control unit 130, a recognition unit 140, and a switching control unit 150.

### Driving Assist Mode Control Unit 130

The driving assist mode control unit 130 determines an autonomous driving mode (autonomous driving assisting state) to be executed by the driving assist control unit 120 based on an operation of the HMI 35 by the driver, an event determined by an action plan generation unit 144, how the host vehicle M should travel determined by a path generation unit 147, and so on. The autonomous driving mode determined is notified to the HMI control unit 170.

Each autonomous driving mode can be switched (overridden) to a lower-level autonomous driving mode through an operation of a configuration element of the driving operation system in the HMI 35.

The override is initiated, for example, when a configuration element of the driving operation system in the HMI 35 by the driver of the host vehicle M continues to be operated for longer than a predetermined time, when a predetermined amount of change in operation (e.g., the accelerator position of the accelerator pedal 41, the brake depression amount of the brake pedal 47, or the steering angle of the steering wheel 55) is exceeded, when a configuration element of the driving operation system is operated more than a predetermined number of times, or the like.

### Recognition Unit 140

The recognition unit 140 includes a host vehicle position recognition unit 141, an outside recognition unit 142, an area identification unit 143, the action plan generation unit 144, and the path generation unit 147.

### Host Vehicle Position Recognition Unit 141

The host vehicle position recognition unit 141 recognizes the traveling lane which the host vehicle M is currently traveling and the position of the host vehicle M relative to the traveling lane, based on the accurate map information 181 stored in the storage unit 180 and information inputted from the cameras 11, the radars 13, the LiDARs 15, the navigation device 20, or the vehicle sensor 30.

The host vehicle position recognition unit 141 recognizes the traveling lane by comparing the pattern of road section lines recognized from the accurate map information 181 (e.g., the arrangement of continuous lines and broken lines) and the pattern of the road section lines around the host vehicle M recognized from images captured by the cameras 11. In this recognition, the current position of the host vehicle M obtained from the navigation device 20 and the result of processing by the INS may be taken into account.

### Outside Recognition Unit 142

As illustrated in FIG. 2, the outside recognition unit 142 recognizes an outside situation including, for example, positions, vehicle speeds, and accelerations of nearby vehicles based on the information on the outside inputted from the external sensor 10 including the cameras 11, the radars 13, and the LiDARs 15. The nearby vehicles refer to, for example, vehicles traveling around the host vehicle M in the same direction as the host vehicle M.

The positions of the nearby vehicles may be represented as the centers of gravity of these other vehicles or representative points such as corners or represented as areas expressed by the contours of the other vehicles. The states of the nearby vehicles may include the accelerations of the nearby vehicles and whether the nearby vehicles are changing lanes (or whether they are about to change lanes) which are figured out based on information from the above-mentioned various instruments. In addition, the outside recognition unit 142 may employ a configuration that recognizes the positions of targets including guard rails, utility poles, parked vehicles, pedestrians, and traffic signs, as well as the nearby vehicles.

In embodiments of the present invention, among the nearby vehicles, the vehicle that is traveling immediately ahead of the host vehicle M and is a following target in a following travel control will be referred to as “leading vehicle”.

### Area Identification Unit 143

The area identification unit 143 obtains information on specific areas present around the host vehicle M (interchanges: ICs, junctions: JCTs, and points where the number of lanes increases or decreases) based on map information. This allows the area identification unit 143 to obtain the information on the specific areas that assist the host vehicle M to travel smoothly even if the host vehicle M is hidden behind vehicles ahead including the leading vehicle and cannot capture an image in the direction of advance with the external sensor 10.

Instead of obtaining the information on the specific areas based on the map information, the area identification unit 143 may obtain the information on the specific areas by identifying targets by image processing based on an image in the direction of advance captured with the external sensor 10 or by recognizing targets based on the contours in an image in the direction of advance by internal processing by the outside recognition unit 142.

Also, a configuration may be employed which, as is described below, uses the VICS information obtained by the communication device 25 to enhance the accuracy of the information on the specific areas obtained by the area identification unit 143.

### Action Plan Generation Unit 144

The action plan generation unit 144 sets the start point of autonomous driving and/or the destination point of the autonomous driving. The start point of the autonomous driving may be the current position of the host vehicle M or a geographical point at which an operation is performed as an instruction to perform the autonomous driving. The action plan generation unit 144 generates an action plan in a zone from this start point to the destination point of the autonomous driving. Note that the action plan is not limited to the above, and the action plan generation unit 144 may generate action plans for any zones.

The action plan is formed of, for example, a plurality of events to be executed in turn. Examples of the plurality of events include: a deceleration event in which the host vehicle M is caused to decelerate; an acceleration event in which the host vehicle M is caused to accelerate; a lane keep event in which the host vehicle M is caused to travel so as not to depart from its traveling lane; a lane change event in which the host vehicle M is caused to change its traveling lane; a passing event in which the host vehicle M is caused to pass the leading vehicle; a branching event in which the host vehicle M is caused to change its traveling lane to the desired lane at a branching point or to travel so as not to depart from the current traveling lane; a merge event in which the host vehicle M is in a merging lane for merging into a main lane and is caused to accelerate or decelerate and change its traveling lane; a handover event in which the host vehicle M is caused to transition from the manual driving mode to the autonomous driving mode (autonomous driving assisting state) at the start point of the autonomous driving or transition from the autonomous driving mode to the manual driving mode at the scheduled end point of the autonomous driving; and so on.

The action plan generation unit 144 sets a lane change event, a branching event, or a merge event at each point where the target lane determined by the target lane determination unit 110 changes. Information indicating the action plan generated by the action plan generation unit 144 is stored in the storage unit 180 as action plan information 183.

The action plan generation unit 144 includes a mode changing unit 145 and a notification control unit 146.

### Mode Changing Unit 145

On a base of, for example, the result of recognition of the targets present in the direction of advance of the host vehicle M by the outside recognition unit 142, the mode changing unit 145 selects a driving mode suitable for the recognition result among driving modes including a plurality of preset levels of autonomous driving modes and the manual driving mode; and causes the host vehicle M to perform autonomous driving using the selected driving mode.

### Notification Control Unit 146

When the mode changing unit 145 changes the driving mode of the host vehicle M, the notification control unit 146 issues a notice indicating the driving mode of the host vehicle M has been changed. The notification control unit 146, for example, causes the speakers 63 to output audio information prestored in the storage unit 180 to issue the notice indicating that the driving mode of the host vehicle M has been changed.

Note that the notice is not limited to an audio notice. The notice may be issued in the form of a display, emitted light, a vibration, or a combination of these as long as it can notify the driver of the change in the driving mode of the host vehicle M.

### Path Generation Unit 147

The path generation unit 147 generates a path which the host vehicle M should travel, based on the action plan generated by the action plan generation unit 144.

### Switching Control Unit 150

As illustrated in FIG. 2, the switching control unit 150 switches the driving mode between an autonomous driving mode and the manual driving mode based on a signal inputted from the autonomous driving ON/OFF switch 71 (see FIG. 3) and other input signals. Also, based on an operation of a configuration element of the driving operation system in the HMI 35 performed as an accelerating, decelerating, or steering instruction, the switching control unit 150 switches the current autonomous driving mode to a lower-level driving mode. For example, if a state where an operation amount indicated by a signal inputted through a configuration element of the driving operation system in the HMI 35 is over a threshold value continues for a reference time or longer, the switching control unit 150 switches (overrides) the current autonomous driving mode to a lower-level driving mode.

Also, the switching control unit 150 may perform switching control that brings the driving mode back to the original autonomous driving mode if detecting no operation on any configuration elements of the driving operation system in the HMI 35 for a predetermined time after the switching to the lower-level driving mode by the override.

### Travel Control Unit 160

The travel control unit 160 controls travel of the host vehicle M by controlling the travel drive force output device 200, the steering device 210, and the brake device 220 such that the host vehicle M will pass through the path generated by the path generation unit 147, on which path the host vehicle M should travel, on the scheduled time.

### HMI Control Unit 170

When notified of setting information on the autonomous driving mode of the host vehicle M by the driving assist control unit 120, the HMI control unit 170 refers to mode-by-mode operation permission information 184 (see FIG. 2) and controls the HMI 35 according to contents set for the autonomous driving mode. The mode-by-mode operation permission information 184 is information indicating a device (a part or all of the navigation device 20 and the HMI 35) that is permitted for each operation mode to use and a device that is not permitted to use.

As illustrated in FIG. 2, based on the information on the driving mode of the host vehicle M obtained from the driving assist control unit 120 and by referring to the mode-by-mode operation permission information 184, the HMI control unit 170 determines the devices permitted to be used (the navigation device 20 and part or entirety of the HMI 35) and the devices not permitted to be used. Also, based on the result of the above determination, the HMI control unit 170 controls whether to accept the driver's operations of the driving operation system in the HMI 35 and the navigation device 20.

For example, when the driving mode executed by the vehicle control device 100 is the manual driving mode, the HMI control unit 170 accepts the driver's operations of the driving operation system in the HMI 35 (e.g., the accelerator pedal 41, the brake pedal 47, the shift lever 51, the steering wheel 55, and so on; see FIG. 3).

The HMI control unit 170 includes a display control unit 171.

### Display Control Unit 171

The display control unit 171 controls display on the interior display device 61 and the exterior display device 83. Specifically, for example, when the driving mode executed by the vehicle control device 100 is an autonomous driving mode with a high degree of autonomy, the display control unit 171 performs control that causes the interior display device 61 and/or the exterior display device 83 to display information such as a reminder, warning, or driving assistance to traffic participants present around the host vehicle M. This is described below in detail.

### Storage Unit 180

The storage unit 180 stores pieces of information such as the accurate map information 181, the target lane information 182, the action plan information 183, and the mode-by-mode operation permission information 184, for example. The storage unit 180 is implemented with a ROM, a RAM, a hard disk drive (HDD), a flash memory, or the like. The programs to be executed by the processor may be prestored in the storage unit 180 or downloaded from an external device via an in-vehicle Internet device or the like. Alternatively, the programs may be installed in the storage unit 180 by mounting a mobile storage medium storing the programs to a medium-drive device not illustrated.

The accurate map information 181 is map information that is more precise than the normal map information included in the navigation device 20. The accurate map information 181 contains, for example, information on the centers of lanes, information on the boundaries of the lanes, and so on. The boundaries of the lanes include the types, colors, and lengths of lane marks, widths of roads, widths of road shoulders, widths of main lanes, widths of lanes, positions of boundaries, types of boundaries (guard rail, plant, and curb), hatched zones, and so on, and these boundaries are contained in a precise and accurate map.

The accurate map information 181 may also contain road information, traffic regulation information, address information (addresses and postal codes), facility information, telephone number information, and so on. The road information contains information indicating types of roads such as expressways, tollways, national highways, and prefectural roads, and information on the number of lanes in each road, the width of each lane, gradient of the road, position of the road (three-dimensional coordinates including the longitude, latitude, and height), curvature of the lane, positions of merging or branching points on the lane, signs provided on the road, and so on. The traffic regulation information contains information such as occurrence of lane closures due to construction, traffic accident, congestion, or the like.

### Control of Travel Drive Force Output Device, Steering Device, and Brake Device

As illustrated in FIG. 2, the vehicle control device 100 controls the drive of the travel drive force output device 200, the steering device 210, and the brake device 220 in accordance with a travel control instruction from the travel control unit 160.

### Travel Drive Force Output Device 200

The travel drive force output device 200 outputs a drive force (torque) for traveling of the host vehicle M to its drive wheels. When the host vehicle M is an automobile having an internal combustion engine as a power source, the travel drive force output device 200 includes, for example, the internal combustion engine, a transmission, and an engine electronic control unit (ECU) that controls the internal combustion engine (none of which is illustrated).

Alternatively, when the host vehicle M is an electric automobile having an electric motor as a power source, the travel drive force output device 200 includes a motor for traveling and a motor ECU that controls the motor for traveling (neither of which is illustrated).

Still alternatively, when the host vehicle M is a hybrid automobile, the travel drive force output device 200 includes an internal combustion engine, a transmission, an engine ECU, a motor for traveling, and a motor ECU (none of which is illustrated).

When the travel drive force output device 200 includes only an internal combustion engine, the engine ECU adjusts the throttle opening degree of the internal combustion engine, the shift stage, and so on in accordance with below-described information inputted by the travel control unit 160.

When the travel drive force output device 200 includes only a motor for traveling, the motor ECU adjusts a duty ratio of a PWM signal to be applied to the motor for traveling in accordance with information inputted by the travel control unit 160.

When the travel drive force output device 200 includes an internal combustion engine and a motor for traveling, the engine ECU and the motor ECU cooperate with each other to control the travel drive force in accordance with information inputted by the travel control unit 160.

### Steering Device 210

The steering device 210 includes, for example, a steering ECU and an electric motor (neither of which is illustrated). The electric motor changes the direction of the turning wheels, for example, by exerting force on a rack-and-pinion mechanism. The steering ECU drives the electric motor to change the direction of the turning wheels in accordance with information inputted by the vehicle control device 100 or steering angle or steering torque information inputted.

### Brake Device 220

The brake device 220 is, for example, an electric servo brake device including a brake caliper, a cylinder that transfers hydraulic pressure to the brake caliper, an electric motor that generates the hydraulic pressure in the cylinder, and a braking control unit (none of which is illustrated). The braking control unit of the electric servo brake device controls the electric motor to output a brake torque corresponding to a braking operation to each wheel in accordance with information inputted from the travel control unit 160. The electric servo brake device may include a mechanism that transfers hydraulic pressure generated by operating the brake pedal to the cylinder through a master cylinder for a backup.

Note that the brake device 220 is not limited to the above-described electric servo brake device and may be an electronically controlled hydraulic brake device. The electronically controlled hydraulic brake device controls an actuator to transfer hydraulic pressure in a master cylinder to a cylinder in accordance with information inputted by the travel control unit 160. Also, the brake device 220 may include a regenerative brake using a motor for traveling that can be included in the travel drive force output device 200.

### Details of Display Control Unit 171

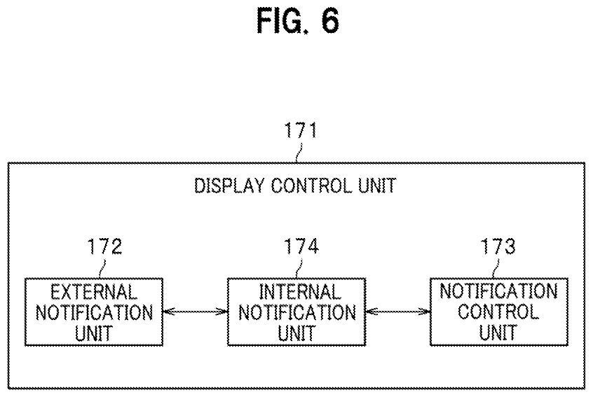

FIG. 6 is a functional block diagram illustrating details of a display control unit 171. As shown in FIG. 6, the display control unit 171 includes an external notification unit 172, an internal notification unit 173, and a notification control unit 174. The display control unit 171 implements a vehicle control method of the present invention by the vehicle control process described below. This process is executed based on a predetermined program, and this predetermined program carries out the method of the present invention.

As described above, the nearby information around the host vehicle M can be recognized based on the detection results of the recognition unit 140 (outside recognition unit 142) and the external sensor 10. Then, in the autonomous driving mode, the driving assist control unit 120 and the travel control unit 160, which are the travel control units of the present invention, control the driving force output device 200, the steering device 210, and the braking device 220 to perform autonomous driving. The autonomous driving here is performed by controlling all of the travel drive force output device 200, the steering device 210, and the brake device 220. However, autonomous control of only the steering of the host vehicle M may be performed by controlling only the steering device 210, or autonomous control of only the acceleration of the host vehicle M may be performed by controlling only the travel drive force output device 200 and the brake device 220.

### External Notification Unit 172

An external notification unit 172 notifies the behavior of the host vehicle M based on the control performed by such an autonomous driving mode to traffic participants such as a pedestrian and a bicycle-rider recognized by the recognition unit 140 (outside recognition unit 142). Specifically, such a notification is performed by controlling the exterior display device 83.

### Internal Notification Unit 173

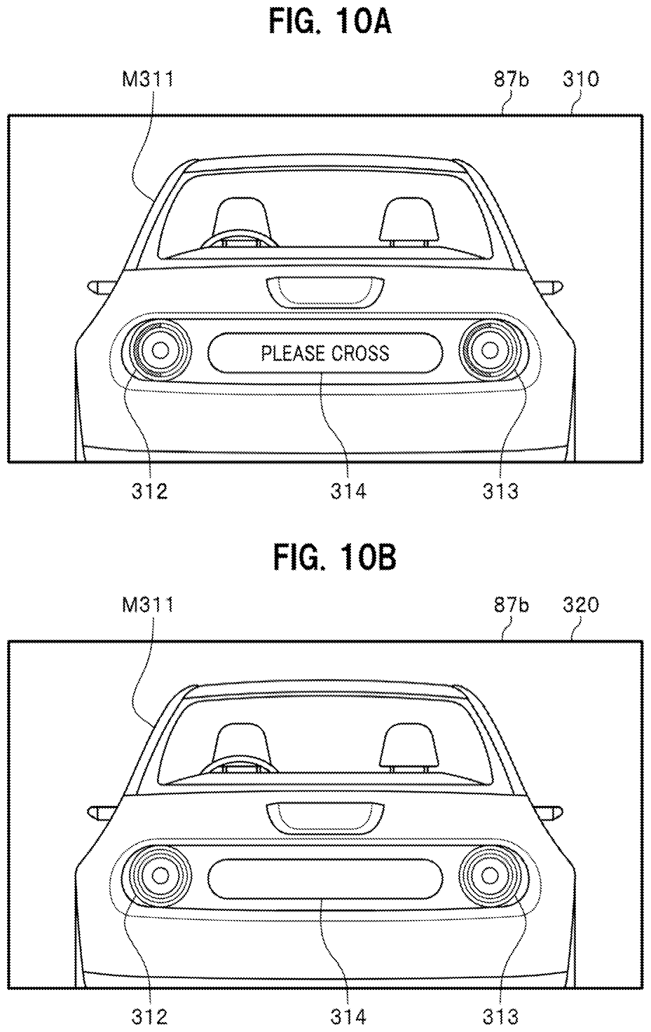

The internal notification unit 173 notifies as well as the driver of the host vehicle M of the content of the notification given to the traffic participants such as such as a pedestrian and a bicycle-rider through the external notification unit 172. Specifically, the notification is performed by controlling the interior display device 61. Further, it is preferable that such notification is also performed by a voice message from the speaker 63. Furthermore, it is also preferable to use a means such as lighting of an indicator (not shown). The internal notification unit 173 may perform a notification display 310 (a first notification, see FIG. 10A) or a non-notification display 320 (a second notification, see FIG. 10B). The notification display 310 notifies the driver of the content of the notification given to the traffic participants such as a pedestrian and a bicycle-rider through the external notification unit 172; and the non-notification display 320 notifies the driver of a content different from the content of the notification given to the traffic participant. The image used for the first notification 310 and the second notification 320 is stored in, for example, the storage unit 180 as notification image information 185 (see FIG. 2).

### Notification Control Unit 174

The notification control unit 174, when the recognition unit 140 (specifically its outside recognition unit 142) detect the traffic participants such as a pedestrian and a bicycle-rider nearby the host vehicle M (e.g., its front direction), notifies the traffic participant of the behavior of the host vehicle M through the external notification unit 172; and further the notification control unit 174 notifies the driver through the internal notification unit 173 of the content of the notification given through the external notification unit 172.

Thereafter, the notification control unit 174, when the recognition unit 140 (specifically its outside recognition unit 142) detects that the above-described traffic participants are no longer detected nearby the host vehicle M (e.g., its front direction), stops the notification through the external notification unit 172 to the traffic participants; and further stops also the notification to the driver through the internal notification unit 173 of the content of the notification given through the external notification unit 172.

In this case, when the recognition unit 140 (specifically its outside recognition unit 142) detects that the traffic participants such as a pedestrian and a bicycle-rider are no longer detected in the front direction nearby the host vehicle M, the internal notification unit 173 performs the non-notification display 320 instead of the notification display 310. The notification display 310 is a display to inform the driver that a predetermined notification is being given to the traffic participants such as a pedestrian or a bicycle-rider through the external notification unit 172. The non-notification display 320 is a display to notify the driver that the predetermined notification is not being given to the traffic participant, irrelevant to notifying the driver that such a predetermined notification is being given to the traffic participant.

In this case, when the host vehicle M is located in a specific scene, the notification control unit 174 performs the external notification through the external notification unit 172, and the notification display 310 and the non-notification display 320 through the internal notification unit 173; and when the host vehicle M is not located in the specific scene, the notification control unit 174 stops the notification through the internal notification unit 173.

The “specific scene” means, for example, that the host vehicle M is located “within a predetermined area of an intersection”. As described above, the position information of the host vehicle M can be acquired by the host vehicle position recognition unit 141 (acquisition unit). This position information can be acquired from the accurate map information 181 and the like. Therefore, it can be determined by referring to the accurate map information 181 or the like whether or not the host vehicle M is located in the specific scene. Then, the notification control unit 174 performs the external notification through the external notification unit 172 and the notification display 310 and the non-notification display 320 through the internal notification unit 173, while the host vehicle position recognition unit 141 is detecting that the host vehicle M is located in the predetermined area of the intersection. The accurate map information 181 includes information on what range of each intersection is specifically directed by “within a predetermined area of the intersection”. The notification control unit 174 changes the content of the notification through the internal notification unit 173 in response to the notification content through the external notification unit 172.

When the internal notification unit 173 starts the notification that corresponds to the notification of the external notification unit 172, the internal notification unit 173 continues the notification display 310 or the non-notification display 320 according to the recognition result of the host vehicle position recognition unit 141 until the host vehicle M goes out from “within the predetermined area of the intersection”. When the position of the host vehicle M changes from “within the predetermined area of the intersection” to the outside of this predetermined area, the internal notification unit 173 performs the notification display 310 when the traveling control of the host vehicle M is performing a predetermined control; and otherwise, the internal notification unit 173 performs no notification. The “predetermined control” is a control such as stopping the host vehicle M because a pedestrian is about to cross the road ahead.

The notification control unit 174 controls the notification of the information so that the external notification unit 172 outputs the information in the direction of the traffic participants such as pedestrians and bicycle-riders existing in front of the host vehicle M.

When the notification control unit 174 determines that traffic participants such as a pedestrian or a bicycle-rider exist in a region such as a sidewalk adjacent to an oncoming lane, and the like on the opposite lane (oncoming lane) of the traveling lane in which the host vehicle M exists, the notification control unit 174 does not perform the notification through the external notification unit 172 to such traffic participants, as a general rule.

As described above, the navigation device 20 (navigation display unit) can provide guidance by voice or map display on a route to a destination. A guidance screen from the navigation device 20 can be displayed on the multi-information panel 87 (display). Further, a guidance voice can be output from the speaker 63. The internal notification unit 173 does not perform the internal notification through the internal notification unit 173 when the multi-information panel 87 displays the notification information (nearby information) related to the guidance from the navigation device 20.

### Detailed Process of External Notification Unit 172, Internal Notification Unit 173, and Notification Control Unit 174

Next is a description of the specific process executed by the external notification unit 172, the internal notification unit 173, and the notification control unit 174. The external notification unit 172, the internal notification unit 173, and the notification control unit 174 execute the following process when the operation mode is set to an autonomous driving level 4 by the mode change unit 145, which level is defined by SAE (Society of Automotive Engineers) International. The autonomous driving level 4 can be set by operating the autonomous driving changeover switch 71. The autonomous driving level 4 is operated by the above-mentioned system of the host vehicle M for everything of this level 4 at a specific place. Although the host vehicle M does not support an autonomous driving level 5, if the host vehicle M is also capable of autonomous driving at the autonomous driving level 5, when the driving mode is set to the autonomous driving level 4 or the autonomous driving level 5, the external notification unit 172, the internal notification unit 173, and the notification control unit 174 execute the following processing.

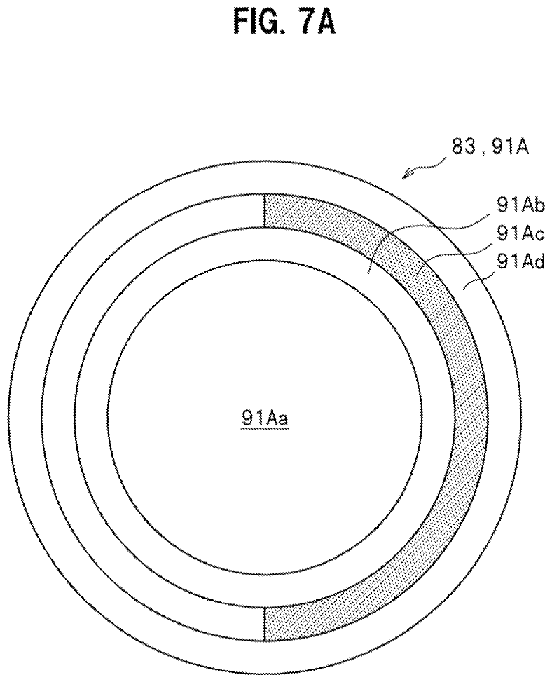

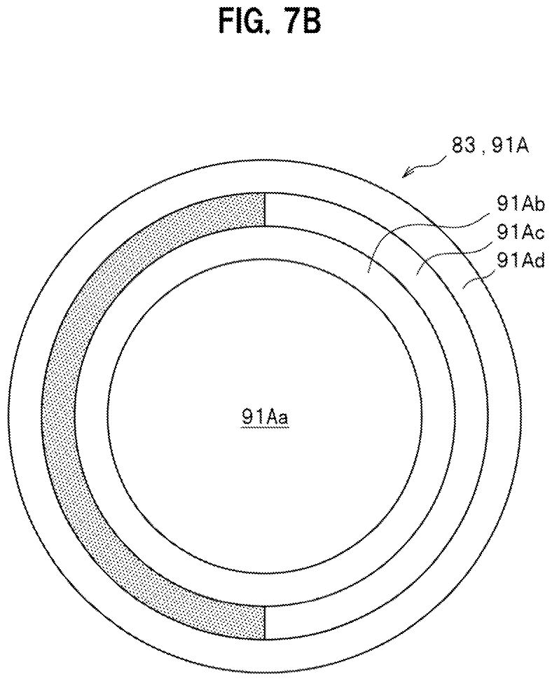

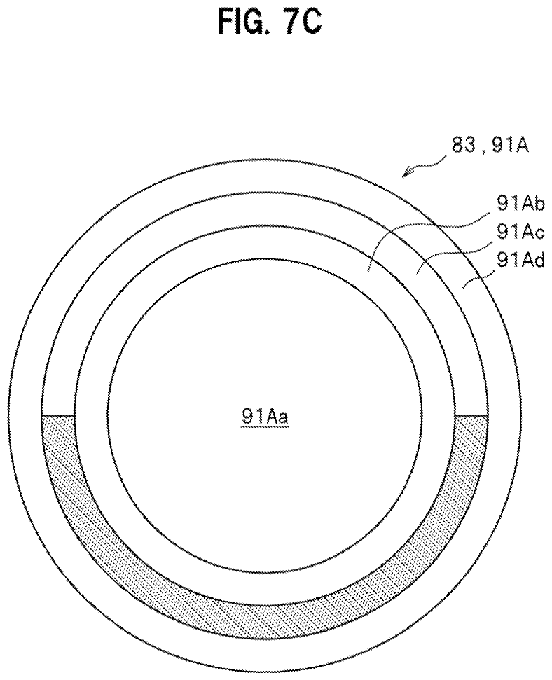

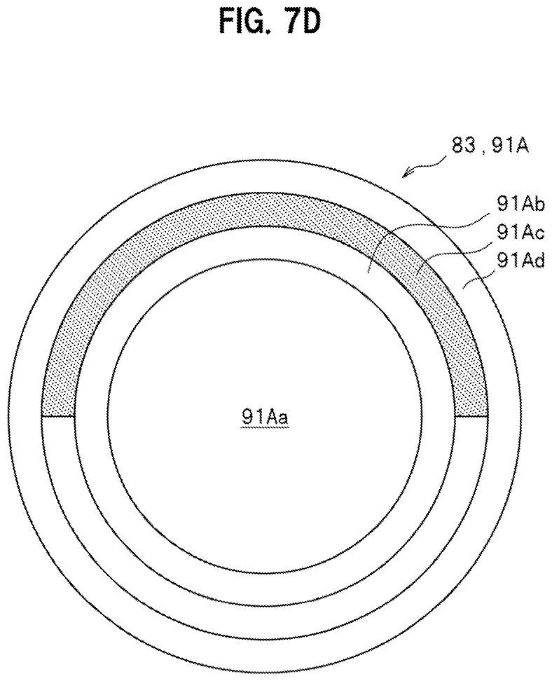

The content of the notification possible through external notification unit 172 is described. First, the notification patterns through the right front lighting unit 91A and the left front lighting unit 91B is described with reference to FIGS. 7A to 7D. Because the content of the notification is the same between the right front lighting unit 91A and the left front lighting unit 91B, the right front lighting unit 91A is exemplified below as a representative. A light indicator 91Ac of the right front lighting unit 91A is structured by integrating, for example, a large number of LEDs (Light Emitting Diodes). The integrated LEDs are partially turned on (with the remaining other LEDs turned off) to perform notification.

More specifically, the right front lighting unit 91A is disposed annularly around a circular headlamp 91Aa. Because the right front lighting unit 91A and the left front lighting unit 91B are arranged on the left and the right of the front grill 90, they are both visible to anthropomorphic eyes from the outside. Therefore, as shown in FIG. 7A, when the right half of the light indicator 91Ac of the right front lighting unit 91A (hereinafter, the same applies to the left front lighting unit 91B) is turned off and the left half is turned on. Note that the extinguished part is indicated by diagonal lines, which is the same in the subsequent figures. This makes the dark part that is turned off looks like black of eye, and the bright part that is turned on looks like white of eyes (therefore, emission color of the light indicator 91Ac is preferably white or a pale color close to white). Then, because the dark part visible to the black of eye is on the right half of the annular light indicator 91Ac, it can be expressed as if both anthropomorphic eyes are looking at the left.

Similarly, as shown in FIG. 7B, it is possible to express as eyes are looking at the right by lighting up the right half and turning off the left half of the lighting display portion 91Ac of the right front lighting unit 91A. As shown in FIG. 7C, when the upper half of the light indicator 91Ac of the right front lighting unit 91A is turned on and the lower half is turned off, it can be expressed as if both eyes are looking at the lower direction. As shown in FIG. 7D, when the lower half of the light indicator 91Ac of the right front lighting unit 91A is turned on and the upper half is turned off, it can be expressed as if both eyes are looking at the upper direction. Note that a ratio of the turned-on area and the turned-off area of the light indicator 91Ac may not have to be half-half, and may be set to various ratios, for example, one is set to 25% and the other is set to 75%. However, in order to express eyes with the right front lighting unit 91A and the left front lighting unit 91B and to make the both eye directions easy to recognize, the ratio of the turned-on area and the turned-off area of the lighting indicator 91Ac indicator should be about half-half.

The notification possible by the external notification unit 172 is displayed also with a message described using characters displayed on the front display unit 93.

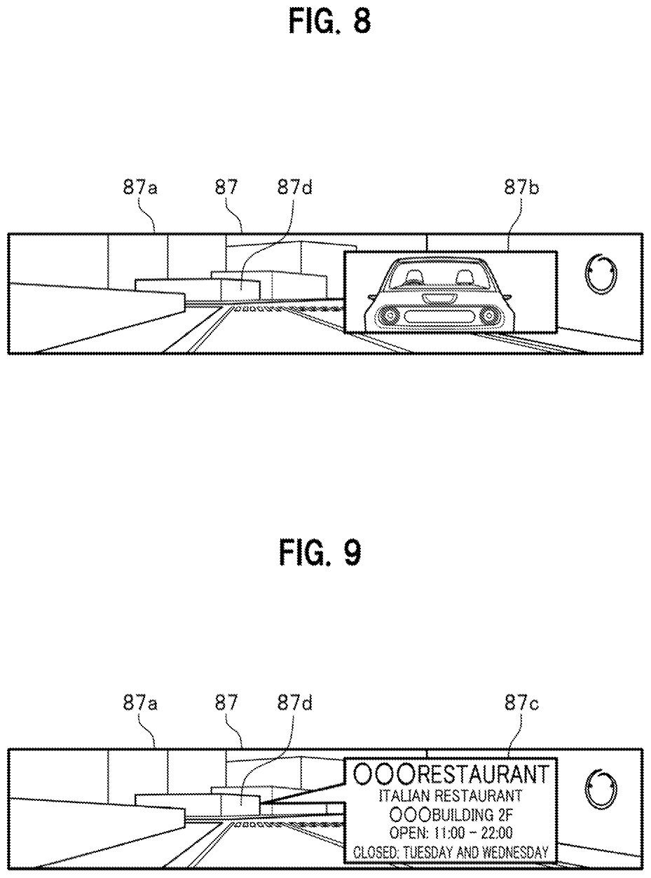

Next is a description of the content notified through the internal notification unit 173. The notification executed by the internal notification unit 173 is implemented by displaying an image on the multi-information panel 87. FIG. 8 is a front view showing an image display example of the multi-information panel 87. As shown in FIG. 4, the multi-information panel 87 is provided in the instrument panel 60. As shown in FIG. 8, the display area 87a also displays the map information nearby the host vehicle M, the current position information of the host vehicle M on the map, the traffic information regarding the current travelling route/planned route of the host vehicle M, and the like (see image 87d). The image 87d is displayed by the navigation device 20 based on the map information (navigation map) and the like of the navigation device 20. The multi-information panel 87 can display an external notification display area 87b as necessary on a part of the display area 87a thereof (a location near the right of the screen in an example of FIG. 8). The external notification display area 87b displays an image showing what kind of notification is currently being given to traffic participants such as pedestrians and bicycle-riders by the external notification unit 172 through the light indicator 91Ac of the right front lighting unit 91A (left front lighting unit 91B) and the front display unit 93. Specifically, the external notification display area 87b displays an image imitating the front part of the host vehicle M, on which image the right front lighting part 91A, the left front lighting part 91B, and the front display unit 93 are clearly displayed.

FIG. 9 is a front view of the multi-information panel 87 when the announce information 87c related to the above guidance is displayed. This announce information 87c related to the guidance introduces information on landmarks, restaurants, various shops, etc. existing on the future travelling route of the host vehicle M. The announce information 87c is announced through a voice guidance of the speaker 63 as well as the image display in the multi-information panel 87. In the example of FIG. 9, a guide about an Italian restaurant located in front of the host vehicle M is displayed in a balloon. The announce information 87c related to the guidance is displayed by the navigation device 20 based on the map information (navigation map) of the navigation device 20 and the like. When the announce information 87c related to this guidance is displayed, the external notification display area 87b (FIG. 8) is not displayed on the multi-information panel 87. The display area 87a of the multi-information panel 87, as described above, displays the map information nearby the host vehicle M, the current position information of the host vehicle M on the map, the traffic information regarding the currently travelling route/planned route of the host vehicle M, and the like. The announce information 87c related to the guidance is displayed by being superimposed on the image 87d.

FIG. 10A is a front view of an image display example of the notification display 310 displayed in the external notification display area 87b. The notification display 310 displays an image that notifies the driver of the content of the notification that is performed for the traffic participants such as pedestrians and bicycle-riders by the external notification unit 172. In the example of FIG. 10A, anthropomorphic eyes of the right front lighting unit 91A and the left front lighting unit 91B (FIG. 5A) are displayed as if they are looking at the right in the traveling direction. Therefore, the notification display 310 displays anthropomorphic eyes of the right front lighting unit 312 and the left front lighting unit 313 corresponding to the right front lighting unit 91A and the left front lighting unit 91B in a host vehicle image M311 that imitates the host vehicle M as if they were looking at the right in the travelling direction similarly to the right front lighting unit 91A and the left front lighting unit 91B. Further, the example in FIG. 10A shows a case in which the front display unit 93 displays a message “Please cross”, and the front display unit 314 that is the image corresponding to the front display unit 93 in the host vehicle image M311 that is an imitation of the host vehicle M. similarly displays the message “Please cross”.

FIG. 10B is a front view of an image display example of the non-notification display 320 displayed in the external notification display area 87b. The non-notification display 320 displays an image that notifies the driver that no notification is performed when the external notification unit 172 does not notify the traffic participants such as pedestrians and bicycle-riders. In the non-notification display 320, the right front lighting unit 312 and the left front lighting unit 313 each is in all-turn-on state or all-turn-off state, and anthropomorphic eyes of the right front lighting unit 91A and the left front lighting unit 91B are represented as looking straight. Further, no message is displayed on the front display unit 314 that is an image imitating the front display unit 93.

Next, a description is given of process that is executed by the external notification unit 172, the internal notification unit 173, and the notification control unit 174 when the autonomous driving is actually performed.

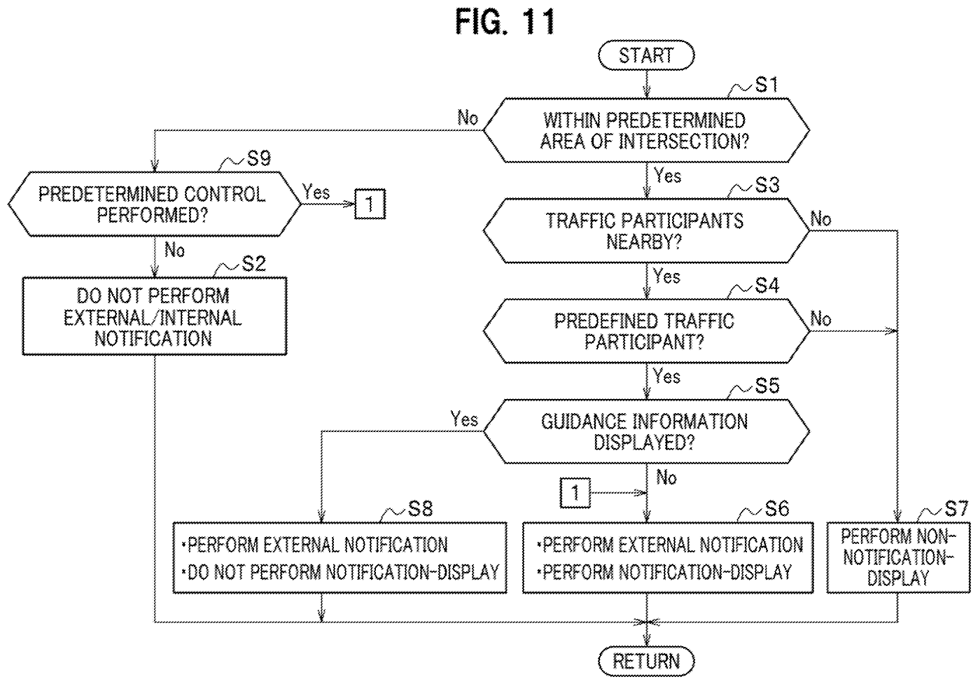

FIG. 11 is a flowchart illustrating the process executed by the notification control unit 174 and the like. First, the notification control unit 174 determines whether or not the host vehicle M is within the predetermined area of the intersection (S1). As described above, the notification control unit 174 can determine whether or not the host vehicle M is within the predetermined area of the intersection using the host vehicle position recognition unit 141 and the accurate map information 181. When the notification control unit 174 determines that the host vehicle M is outside the predetermined area of the intersection (No in S1), the notification control unit 174 does not perform any notification through the external notification unit 172 and the internal notification unit 173 (step S2). In this case, the multi-information panel 87 does not display thereon the external notification display area 87b but display only the map information nearby the host vehicle M, the current position information of the host vehicle M on the map, and the traffic information on the currently travelling path and planned route of the host vehicle M (image 87d) and the like are displayed (see FIG. 8).

When the host vehicle M enters the predetermined area of the intersection (Yes in S1), the notification control unit 174 determines whether or not it has detected traffic participants nearby the host vehicle M: on the front direction in this example (S3). Note that the range of the “front direction” is, for example, a 180° range of the front area of the host vehicle M and includes not only the roadway but also the sidewalk. When the traffic participants are detected on the front direction (Yes in S3), the notification control unit 174 determines whether or not the traffic participant is a predefined traffic participant.

The “predefined traffic participant” is a pedestrian or a bicycle-rider because those who crosses a crosswalk at an intersection are a pedestrian and a bicycle-rider. When applying a predetermined image processing on a captured image of a camera 11 that captures the front of the host vehicle M and making it sure that there are pedestrians or bicycle-riders in front of the host vehicle M, the notification control unit 174 make sure their position and to make them candidates for the predefined traffic participant.

Next, the predefined traffic participants are recognized among the candidates for the predefined traffic participant from their positions and facing directions (by determining whether or not they are present near a crosswalk and facing to cross or crossing the crosswalk). First, when a pedestrian or a bicycle-rider is determined to be about to cross or currently crossing the intersection ahead him/her, the pedestrian or the bicycle-rider may be determined to be the predefined traffic participant. Not only the pedestrians and bicycle-riders crossing the crosswalk in front of the host vehicle M, but also those who are about to cross or crossing crosswalks on the right or left turn directions may be recognized as predefined traffic participants.

Traffic participants on the oncoming lane (including sidewalks) may not need to be included in the predefined traffic participants, but pedestrians and bicycle-riders who are about to cross or are crossing the intersection in front of the host vehicle M are recognized as the predefined traffic participant.

Even a pedestrian or a bicycle-rider who is moving on the sidewalk adjacent to the lane on which the host vehicle M is traveling may not need to be recognized as the predefined traffic participant if they are in a distant location from the crosswalk at the intersection whose location is also known from the accurate map information 181.

Furthermore, when a signal (not shown) at the intersection is red, or when a pedestrian or a bicycle-rider is crossing or is about to cross the intersection in front of the host vehicle M, the host vehicle M autonomously stops at a predetermined position in front of the intersection. For example, when the traffic participant on the front direction is recognized to be a predefined traffic participant (Yes in S4) as described above, the notification control unit 174 determines whether or not the announce information 87c relating to the guidance, that is the nearby information (see FIG. 9) is displayed on the multi-information panel 87 (S5).

When the announce information 87c relating to the guidance is displayed on the multi-information panel 87 (Yes in S5), the notification control unit 174 executes the step of S6, as follows. First, the notification control unit 174 performs the notification through the external notification unit 172. Specifically, for example, when a pedestrian or the like exists on the left in the traveling direction, or when a pedestrian or the like crosses the crosswalk in front of the vehicle from the left, the notification control unit 174 makes the external notification unit 172 change the display so that the anthropomorphic eyes of the right front lighting unit 91A and the left front lighting unit 91B face the left in the traveling direction (FIGS. 5A and 7A). In other words, the display is provided as if the anthropomorphic eyes are watching the traffic participants such as pedestrians. At the same time, the notification control unit 174 also displays a message such as “waiting for crossing” on the front display unit 93 through the external notification unit 172 (FIG. 5A). The process of S6 is performed when the host vehicle M approaches the predefined traffic participants to be notified by the external notification unit 172 to some extent.

In this case, if there is a pedestrian or the like on the right side, or if a pedestrian or the like comes crossing the crosswalk in front of the host vehicle M from the right, the anthropomorphic eyes of the right front lighting unit 91A and the left front lighting unit 91B are changed to face the right in the travelling direction (FIG. 7B). The display of the front display unit 93 is the same as described above.

Further, when there are pedestrians or the like on both the right and left, the anthropomorphic eyes of the right front lighting unit 91A and the left front lighting unit 91B may be made to alternately look at the right and left. Furthermore, when the pedestrian on the right first starts to cross the crosswalk, and then the pedestrian on the left starts to cross the crosswalk, the anthropomorphic eyes of the right front lighting part 91A and the left front lighting part 91B may be made to first look at the right and then the left. Furthermore, when a pedestrian or the like is already crossing the crosswalk in front of the host vehicle M, the anthropomorphic eyes of the right front lighting unit 91A and the left front lighting unit 91B may be made to move their eyes up and down. (FIGS. 7C and 7D).

In addition, in the step S6, the notification control unit 174 also performs the notification display 310 (FIG. 10A) through the internal notification unit 173 in parallel with the notification process of the external notification unit 172. In the notification display 310, the anthropomorphic eyes of the right front lighting unit 312 and the left front lighting unit 313 of the host vehicle M311 are display in the same manner as the display of the right front lighting unit 91A and the left front lighting unit 91B (FIG. 10A). That is, for example, if the right front lighting unit 91A and the left front lighting unit 91B are displayed as looking at the left, the right front lighting unit 312 and the left front lighting unit 313 are also displayed as looking at the left. The display of the front display unit 314 is also the same as that of the front display unit 93. In this way, the displays of the right front lighting unit 312, the left front lighting unit 313, and the front display unit 314 changes in response to the change of the displays of the right front lighting unit 91A, the left front lighting unit 91B, and the front display unit 93, so that both displays are always the same.

On the other hand, when there is no traffic participant on the front direction (No in S3), or when the traffic participant is not the predefined traffic participant (No in S4), the notification control unit 174 performs the non-notification display 320 (FIG. 10B) through the internal notification unit 173 (S7). In this case, in the non-notification display 320, the right front lighting unit 312, the left front lighting unit 313, and the front display unit 314 of the host vehicle M311 do not change all the time and do not notify any message.

Further, when the announce information 87c relating to the guidance is displayed on the multi-information panel 87 as shown in FIG. 9 (Yes in S5), the notification control unit 174 notifies the traffic participants through the external notification unit 172 in the same manner as described above; however, the notification through the internal notification unit 173 is not performed (S8). In this case, the multi-information panel 87 displays the announce information 87c relating to the guidance interposed on the map information nearby the host vehicle M, the current position information of the host vehicle M on the map, the traffic information regarding the current travel route/planned route of the host vehicle M, and the like (image 87d). The step of S8 is performed when the host vehicle M approaches the predefined traffic participant to be notified by the external notification unit 172 to some extent.

After the host vehicle M goes out of the predetermined area (No in S1) that it has entered, the notification control unit 174 determines whether or not the predetermined control is conducted by the traveling control of the host vehicle M (S9). The predetermined control is a control which causes the host vehicle M to stop moving or the like in order to wait for the pedestrians who are about to cross or crossing the front of the host vehicle M. When the traveling control of the host vehicle M is performing the predetermined control (Yes in S9), the notification control unit 174 proceeds with the step S6; otherwise (No in S9), the notification control unit 174 cancels (does not execute) the notification through the external notification unit 172 and the internal notification unit 173 (S2).

In addition, if no traffic participant is detected nearby the host vehicle M (the front side in this example) (No in S3) or no traffic participants remains (No in S4), including if the host vehicle M passes by the predefined traffic participants, the above-mentioned notification through the external notification unit 172 and the notification display 310 are stopped, and the non-notification display 320 is performed, as shown in FIG. 10B (S7).

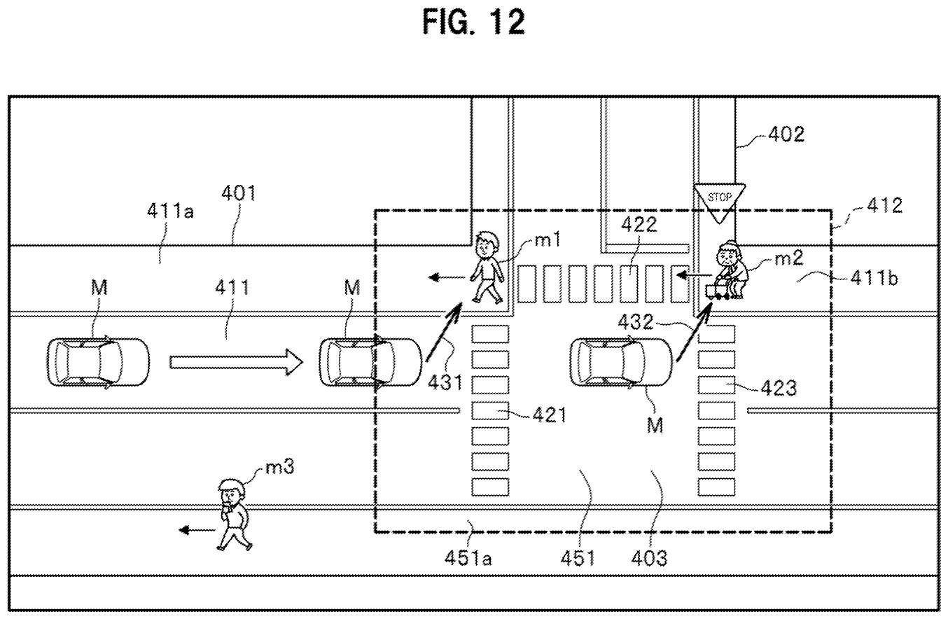

Next is a description of the process of FIG. 11 with a specific example. FIG. 12 is a plan view schematically showing the host vehicle M entering to the intersection. In FIG. 11, a road 401 extending in the right-left direction and a road 402 extending in the up-down direction connect to each other to form an intersection 403 that is a T-junction. And the host vehicle M travels on the road 401 from the left to the right in the left lane 411 of the road 401 and enters the intersection 403.

The predetermined region 412 of the intersection determined in S1 is shown by a broken line as shown in FIG. 12. Crosswalks 421 to 423 are provided at the intersection 403. The host vehicle M detects an object in front thereof with an external sensor 10, particularly a camera 11. The outside recognition unit 142 performs image processing of the camera 11 to capture a pedestrian m1 in the vicinity of the crosswalk 421 on the sidewalk 411a adjacent to the lane 411 in front of the host vehicle M. This makes the notification control unit 174 recognize the pedestrian m1 who is a traffic participant in the front thereof (S3). As a result of the image processing, the notification control unit 174 recognizes that the pedestrian m1 is one of the predefined traffic participants of S4, who may be present in the vicinity of the crosswalk 421 and about to cross the crosswalk 421. The host vehicle M autonomously stops just in front of the crosswalk 421 if the pedestrian m1 may possibly cross the crosswalk 421. In another case the vehicle M autonomously stops in front of the crosswalk when the signal (not shown) installed at the intersection 403 turns red.

During this stop, when the pedestrian m1 crosses the crosswalk 421, the notification control unit 174 performs the notification through the external notification unit 172 and the notification display 310. At this time, the anthropomorphic eyes of the right front lighting unit 91A and the left front lighting unit 91B (FIG. 5A) are displayed as if their line of sights are shifted to the left, which is the direction in which the pedestrian m1 exists, as shown by arrow 431. It becomes. In the notification display 310 (FIG. 10A), the same applies to the anthropomorphic eyes of the right front lighting unit 312 and the left front lighting unit 313 of the host vehicle M311. Further, the characters “Waiting for crossing” are displayed on the front display unit 93 (FIG. 5A) and the front display unit 314 (FIG. 10A) in the notification display 310. As a result, the pedestrian m1 knows that he/she is gazed by the host vehicle M from the line of sight of the anthropomorphic eyes of the right front lighting unit 91A and the left front lighting unit 91B and the display of the front display unit 93. Further, the driver of the host vehicle M can know from the notification through the internal notification unit 173 that the host vehicle M is providing the display notifying the pedestrian m1 that the host vehicle M is paying attention to him/her.

On the other hand, even when the pedestrian m1 is only walking on the sidewalk 411a, the notification control unit 174 performs the notification through the external notification unit 172 and the notification display 310. At this time, the anthropomorphic eyes of the right front lighting unit 91A and the left front lighting unit 91B (FIG. 5A) are displayed as if the lines of their sights are shifted to the left that is the direction in which the pedestrian m1 exists, as shown by arrow 431. In the notification display 310 (FIG. 10A), the same applies to the anthropomorphic eyes of the right front lighting unit 312 and the left front lighting unit 313 of the host vehicle M311. However, the characters “waiting for crossing” are not displayed on the front display unit 93 (FIG. 5A) and the front display unit 314 (FIG. 10A) in the notification display 310. As a result, the pedestrian m1 knows that he/she is gazed by the host vehicle M from the line of sight of the anthropomorphic eyes of the right front lighting unit 91A and the left front lighting unit 91B and the display of the front display unit 93. Further, the driver of the host vehicle M can know from the notification through the internal notification unit 173 that the host vehicle M is providing the display notifying the pedestrian m1 that the host vehicle M is paying attention to him/her.

After that, detecting that the pedestrians such as the pedestrian m1 complete the walking on the crosswalk 421, the host vehicle M autonomously departs; or detecting that the signal at the intersection 303 turns green (after confirming that there are no pedestrians present on the crosswalk 421), the host vehicle M autonomously starts. Then, when the pedestrian m1 no longer exists in front of the host vehicle M (when the pedestrian m1 has completely crossed the crosswalk 421 or the signal at the intersection 403 turns green and the host vehicle M departs so that the pedestrian m1 is behind the host vehicle M, and the like), the notifications through the external notification unit 172 and the internal notification unit 173 are stopped.

After that, the host vehicle M advances in the intersection 403, and the outside recognition unit 142 processes image of the camera 11 and catches a pedestrian m2 in the vicinity of the crosswalk 422 on the sidewalk 411b that is adjacent to the lane 411 in front of the host vehicle M. This makes the notification control unit 174 recognize the pedestrian m2 as a traffic participant in front of the host vehicle M (S3). As a result of the image processing, the notification control unit 174 recognizes that the pedestrian m2 is a predefined traffic participant in the step S4, who may be facing the crosswalk 422 and about to cross the crosswalk 422.

If there are no pedestrians crossing the crosswalk 423 when there is no signal, or if the signal at the intersection 403 is blue, the host vehicle M does not autonomously stop just in front of the crosswalk 423. However, when the host vehicle M approaches the pedestrian m2 to some extent, the notification control unit 174 executes the notification through the external notification unit 172 and the notification display 310. At this time, the anthropomorphized eyes of the right front lighting unit 91A and the left front lighting unit 91B (FIG. 5A) are displayed as if their line of sights are shifted to the left that is the direction in which the pedestrian m2 exists, as shown by arrow 432. It becomes. In the notification display 310 (FIG. 10A), the same applies to the anthropomorphic eyes of the right front lighting unit 312 and the left front lighting unit 313 of the host vehicle M311. Further, the characters “waiting for crossing” are displayed on the front display unit 93 (FIG. 5A) and the front display unit 314 (FIG. 10A) in the notification display 310. As a result, the pedestrian m2 can know that the host vehicle M is looking at him/her by seeing the anthropomorphic line of sight of eyes of the right front lighting unit 91A and the left front lighting unit 91B and the character display of the front display unit 93. Further, the driver of the host vehicle M can know from the notification through the internal notification unit 173 that the display for notifying the pedestrian m2 that the host vehicle M is paying attention to him/her is providing to him/her.

Thereafter, when the host vehicle M passes through the side of the pedestrian m2 so that there exists not the pedestrian m2 seen on the front direction of the host vehicle M, the notifications through the external notification unit 172 and the internal notification unit 173 are stopped.

In addition, there exists a pedestrian m3 on the sidewalk 451a adjacent to the oncoming lane 451 of the lane 311 on which the host vehicle M is travelling. However, the pedestrian m3 does not exist in the predetermined area 412 of the intersection. Further, in principle, the traffic participant on the sidewalk of the oncoming lane 451 of the lane 311 on which the host vehicle M is travelling does not correspond to the predefined traffic participant in the step S4. Therefore, the pedestrian m3 is not provided with the notification through the external notification unit 172, and therefore the notification through the internal notification unit 173 is not provided to the driver. However, when detecting that the pedestrian m3 is crossing or about to cross a place where there is no crosswalk on the road 401, the host vehicle M autonomously stops so as to avoid the pedestrian m3, performs the notification through the external notification unit 172 to the pedestrian m3, and performs the notification through the internal notification unit 173 to the driver.

### Effect of the Present Embodiment

The host vehicle M is performing autonomous driving at the autonomous driving level 4. Therefore, the driver of the host vehicle M is not always paying attention to the outside, and sometimes looking aside, sometimes looking through a document, a mobile phone, or the like, or facing sideways to chat with a fellow passenger. This may make other traffic participants think that the driver of the host vehicle M is not paying attention to them and may give them anxiety.

However, the vehicle control device 100 of the host vehicle M according to the present embodiment can notify the traffic participants such as a pedestrian and a bicycle-rider existing nearby the host vehicle M that the host vehicle M is watching the traffic participants through the external notification unit 172. Therefore, the host vehicle M can suppress itself from giving anxiety to the other traffic participants.

Further, the fact that the external notification unit 172 is notifying other traffic participants is also notified to the driver of the host vehicle M through the internal notification unit 173. Therefore, the driver can properly know that the host vehicle M is watching other traffic participants, so that the driver can easily obtain a feeling of security.

Further, the vehicle control device 100 of the host vehicle M, when the traffic participants such as pedestrians and bicycle-riders are no longer detected in the front of the host vehicle M, stops notifying the traffic participates through the external notification unit 172, which causes the internal notification unit 173 to perform the non-notification display 320 indicating that no notification is not performed through the external notification unit 172 to the traffic participants, instead of the notification display 310. Therefore, the external notification unit 172 does not indiscriminately notify other traffic participants, which suppresses a situation in which the traffic participants are rather confused by the indiscriminate notification through the external notification unit 172. In addition, the non-notification display 320 informs the driver that the external notification unit 172 is not indiscriminately performing notification to easily give the driver a feeling of security.

Further, the vehicle control device 100 of the host vehicle M performs the notification through the external notification unit 172 and the internal notification unit 173 on condition that the host vehicle M is located in the specific scene. Therefore, the external notification unit 172 provides notification only when the host vehicle M is located in a specific scene where the external notification unit 172 needs to notify other traffic participants in the traveling route of the host vehicle M. Therefore, the notification through the external notification unit 172 is not indiscriminately performed to other traffic participants, which can prevent the other traffic participants from being confused. Further, when the host vehicle M is not located in the specific scene, the internal notification unit 173 does not perform the internal notification so as to notify the driver that the notification through the external notification unit 172 is not indiscriminately provided to other traffic participants and to easily give a feeling of security.

Further, the notification through the internal notification unit 173 is not always performed during autonomous driving but performed only when the host vehicle M is located in the specific scene and the like, which suppress the driver (passenger) from feeling the notification (notification display 310, non-notification display 320) through the internal notification unit 173 is annoying.

Further, since the notification through the internal notification unit 173 is performed only when the host vehicle M is located in the specific scene, other information such as the image 87d and the announce information 87c (FIG. 9) is less likely to be blocked to be displayed on the multi-information panel 87.

Various situations can be set as the specific scene, but the above-described embodiment defines as the specific scene that the host vehicle M is located “within the predetermined area of the intersection”. The intersection is a traffic area where many pedestrians and bicycle-riders cross very often, and therefore, it is very effective to notify other traffic participants that the host vehicle M is paying attention to them by properly performing notification through the external notification unit 172. Further, because the internal notification unit 173 performs the notification at the intersection where the external notification unit 172 needs to perform the notification, the driver is easily given a feeling of security.

Further, once the vehicle control device 100 of the host vehicle M starts the notification through the internal notification unit 173 in accordance with the notification through the external notification unit 172, the notification display 310 or the non-notification display 320 (FIGS. 10A and 10B) through the internal notification unit 173 is continued until the host vehicle M gets out of the situation in which it is located in the specific scene, such as within the predetermined area of the intersection. This helps to give a sense of security to the driver by notifying the driver that the external notification unit 172 properly issues the notification required in the traffic area such as an intersection where the notification through the external notification unit 172 is required.

However, even if the host vehicle M exists outside the predetermined area of the intersection, when the host vehicle M performs a predetermined control, for example, a control such that the host vehicle stops because the pedestrian is crossing in front thereof, the host vehicle M performs the notification through the external notification unit 172 to the pedestrian and the notification to the passenger through the internal notification unit 173 about the notification to the pedestrian, and thereby makes it easier to give a feeling of security to both the pedestrian and the passenger of the host vehicle M.

Further, the vehicle control device 100 of the host vehicle M performs the notification through the external notification unit 172 by directing the lines of sight of the anthropomorphized eyes of the right front lighting unit 91A and the left front lighting unit 91B to the traffic participants such as pedestrians and bicycle-riders who exist in the front direction of the host vehicle M, and the notification display 310 (FIG. 10A) displays to the driver the notification similarly to the notification to the traffic participants such as pedestrians and bicycle-riders existing on the front side of the host vehicle M. Therefore, the target traffic participants can know that they are being watched by the host vehicle M, which helps them to obtain a feeling of security. In addition, the driver can know from the internal notification unit 173 that the anthropomorphic eyes the right front lighting unit 91A and the left front lighting unit 91B are directing their lines of sight toward the target traffic participant, which helps the driver to get a feeling of assurance.

Further, the vehicle control device 100 of the host vehicle M, as a general rule, does not notify through the external notification unit 172 to traffic participants such as pedestrians and bicycle-riders determined to exist in a region opposite to the region in the traveling direction of the host vehicle M (on a sidewalk and the like on the oncoming lane). Therefore, the vehicle control device 100 not notify indiscriminate traffic participants through the external notification unit 172, and therefore, the vehicle control device 100 can suppress confusion of the traffic participants, which the driver can know by not being notified through the internal notification unit 173 or by seeing the non-notification display 320 (FIG. 10B) performed through the internal notification unit 173. And the driver can know that the traffic participants are not confused and easily get a relieved feeling.

Further, the vehicle control device 100 of the host vehicle M, when the navigation device 20 notifies the passengers of the host vehicle M of the announce information 87c (FIG. 9) relating to the guidance, does not notify through the internal notification unit 173. That is, when the announce information 87c relating to the guidance is notified to the passenger of the host vehicle M, this announce notification can be prioritized over the notification through the internal notification unit 173.

### LIST OF REFERENCE SIGNS

20: Navigation device (Navigation Display Unit)

87c: Announce Information Relating To Guidance (Nearby Information)

120: Driving Assist Control Unit (Travel Control Unit)

160: Travel Control Unit (Travel Control Unit)

140 Recognition Unit

141: Host Vehicle Position Recognition Unit (Acquisition Unit)

142: Outside Recognition Unit (Recognition Unit)

172: External Notification Unit

173: Internal Notification Unit

174: Notification Control Unit (Notification Control Unit)

310: Notification Display (First Notification)

320: Non-Notification Display (second Notification)

M: Host Vehicle

What is claimed is:

1. A vehicle control device comprising:
a recognition unit recognizing surrounding circumstances of a host vehicle,
a travel control unit controlling at least one of steering and acceleration of the host vehicle on a basis of the surrounding circumstances recognized by the recognition unit,
an external notification unit notifying a traffic participant recognized by the recognition unit about a behavior of the host vehicle based on a control by the travel control unit,
an internal notification unit notifying a driver of the host vehicle of notified information to the traffic participant notified through the external notification unit, and
a notification control unit that makes the internal notification unit notify the driver of the host vehicle of the notified information when the host vehicle is located in a specific scene; and stops the internal notification unit notifying the driver of the host vehicle of the notified information when the host vehicle is not located in the specific scene.

2. The vehicle control device according to claim 1, wherein the notification control unit determines whether or not the host vehicle is located in the specific scene by referring to map information.

3. The vehicle control device according to claim 1, wherein the notification control unit recognizes that the host vehicle is located in the specific scene when the host vehicle is located within a predetermined area of an intersection.

4. The vehicle control device according to claim 1, comprising a navigation display unit that displays nearby information around a traveling area of the host vehicle,
wherein
the notification control unit does not perform notification to the driver of the host vehicle when the navigation display unit displays predetermined nearby information on a display of the notification control unit.

5. The vehicle control device according to claim 1, wherein
the notification control unit performs notification through the internal notification unit when the travel control unit of the host vehicle is performing a predetermined control even when the host vehicle is outside a predetermined area of an intersection.

6. A method of vehicle control, comprising steps executed under control of a vehicle control device of an autonomous driving vehicle:
a recognition step recognizing surrounding circumstances of a host vehicle,
a travel control step controlling at least one of steering and acceleration of the host vehicle on a basis of the surrounding circumstances recognized by the recognition step,
an external notification step notifying a traffic participant recognized by the recognition step about a behavior of the host vehicle based on a control by the travel control step,
an internal notification step notifying a driver of the host vehicle of notified information given to the traffic participant through the external notification step, and
a notification control step that makes the internal notification step notify the driver of the host vehicle of the notified information when the host vehicle is located in a specific scene; and stops the internal notification step notifying the driver of the host vehicle of the notified information when the host vehicle is not located in the specific scene.

7. A non-transitory storage medium storing vehicle control program, wherein the program causes a computer to function as the vehicle control device according to claim 1.
